(19) United States
(12) Patent Application Publication
(10) Pub. No.: US 2018/0158007 A1
(43) Pub. Date: Jun. 7, 2018

(54) MANAGING PHARMACEUTICAL MULTICHANNEL SALES AND MARKETING APPROACH IN AN INTEGRATED, END-TO-END WAY BASED ON DATA AND PREDICTIONS

(71) Applicant: Andrei Stavro Frangeti, Bucharest (RO)

(72) Inventor: Andrei Stavro Frangeti, Bucharest (RO)

(21) Appl. No.: 15/796,823

(22) Filed: Oct. 29, 2017

Related U.S. Application Data
(60) Provisional application No. 62/413,992, filed on Oct. 28, 2016.

(51) Int. Cl. G06Q 10/06; G06Q 30/02; G06Q 30/00

(52) U.S. Cl. CPC G06Q 10/06315; G06Q 10/06395; G06Q 10/06393; G06Q 30/016; G06Q 30/0204

(57) ABSTRACT

A method for focusing investment in a pharmaceutical product or service is described in which sales and marketing staff utilize one or more computing devices to facilitate investment and interest. In embodiments of the invention a customer trend profile may be generated to indicate sources of growth and value to develop customer base subset having the highest probability of change in a sales period. In embodiments of the invention, the dimension that is a best predictor of a sales representative's success may be determined and performance management focused on those dimensions. Channels and engagement tactics may be utilized in which a customer is more likely to respond, based on the history of interactions.

### PRIORITY CLAIM

This application claims priority to U.S. Patent Application No. 62/413,992, filed Oct. 28, 2016 and titled, “COMMERCIAL EXCELLENCE EXPERT,” the contents of which is incorporated by reference in its entirety.

### BRIEF DESCRIPTION OF THE DRAWINGS

The features and advantages of the present disclosure will be more fully understood with reference to the following detailed description when taken in conjunction with the accompanying figures, wherein:

FIG. 1 is a diagram describing system components in three separate time horizons.

FIG. 2 is a diagram showing an exemplary network of external systems and data sources.

In embodiments, the system may be a cloud-based web application providing web user interfaces optimized for both desktop/laptop and tablet. FIG. 3 describes an exemplary implementation.

FIG. 3 is a diagram of an exemplary hardware configuration.

FIG. 4 is a diagram describing a planning framework.

FIG. 5 is a screenshot of a customer profiling interface.

FIG. 6 shows a concentration curve describing an embodiment of the system.

FIG. 7 shows the potential curve implementation in an embodiment of the system.

FIG. 8 shows a traditional segmentation matrix.

FIG. 9 shows an exemplary segmentation matrix.

FIG. 10 shows a screenshot of an exemplary customer dynamics matrix.

FIG. 11 shows a screenshot of a resource planning function used in embodiments of the system.

FIG. 12 shows a sample strategy synthesis and corresponding key assumptions.

FIG. 13 shows a screenshot of an automated gap analysis and identification signaled through flags used with embodiments of the system.

FIG. 14 is a graph of an automated root cause analysis for the gaps in the plan.

FIG. 15 is a graph of an automated gap analysis between the progress and the plan and synthesize the gaps through flags, as used with embodiments of the system.

FIG. 16 is a chart describing an optimal mix of activities for use with embodiments of the system.

FIG. 17 is a screenshot of a sales dashboard.

FIG. 18 is a screenshot of summary page related to the sales summary.

FIG. 19 is a screen shot of the history of a past cycle.

### DETAILED DESCRIPTION

The present disclosure will be better understood by reference to the following definitions:

A customer is a doctor or healthcare professional (HCP) that can prescribe or recommend the prescription of a pharmaceutical product to patients.

A customer specialty represents the specialization of a particular HCP such as cardiology, general practice, etc.

An organization refers to the sales and marketing organization of a pharmaceutical company's national affiliate.

A business unit is a subset of an organization, dedicated to a specific part of the product portfolio of the company. An organization may have multiple business units.

A channel type is a type or a medium of interaction between a representative of the company and a customer, and may include e-mail, face-to-face meetings, remote calls, websites, events, and so forth.

A channel is a specific instance of a channel type managed by a specific owner. For example, if e-mail is a channel type, the e-mails can be sent by the sales representatives as a follow up to the direct customer engagements, or can be sent by the back office as part of e-mail campaign. Each of this may serve different purposes, may have different owners and therefore are different channels of the same type.

A team represents a set of pharmaceutical sales and marketing professionals—including managers—that focus on the same sub-portfolio and the same types of customers with the same strategy and objectives. A team may have national or regional coverage. A business unit may have multiple teams. The team may own or utilize one or more channels to engage customers.

Content or promotional content can represent a series of ideas, claims, messages and supporting evidence that is communicated to the target audience (customers). The content can be implemented in different formats: text, print, digital, video, interactive digital content, and can be delivered through various media. The purpose of the content is to transmit and support some key messages to the audience.

The key messages represent product claims and benefits and represent the main communication objectives. A key message—such as Superior Efficacy: “Our product has a 12% higher efficacy compared to the golden standard”—can be implemented in different formats and wording adapted to the communication channel and situation.

Typically, the activities of pharmaceutical companies during a year are divided into promotional cycles. A cycle may have any duration, but may preferably be with the quarterly reporting cycle of the company.

In embodiments, the present invention enables focusing the investment and attention of a sales and marketing organization on the areas with the highest probability and size of impact. Segments may include: (1) focusing resources investment (sales personnel) on the customer that have the highest probability to change in the next period; (2) focusing performance management on the dimensions that are the best predictor of a sales representative's success; and (3) allocating the channels and engagement tactics to which a customer is more likely to respond, based on the history of interactions

In embodiments, a unique landscape of solutions for pharmaceutical sales and marketing may come from four specific aspects: (1) a new perspective of customer segmentation and investment allocation; (2) end-to-end coverage of sales and marketing process from strategy planning to execution monitoring and performance management; (3) combination between data and a step by step process that facilitates and drives decision making; and (4) the unique way in which the system stores the history and knowledge, including past organization structure, past strategy, key performance indicators (KPIs) and targets, past execution, results, appraisals and incentives.

In embodiments of the present invention, three time horizons may be managed. A future time horizon may be managed defining the strategy, segmentation and targeting, resources and activity planning for the next cycle. A present horizon may also be managed, tracking and managing the progress of the execution during the current cycle. Lastly, a past horizon may be managed, capturing and storing the full history of past cycles, codifying organization knowledge and enabling predictable, validated learning.

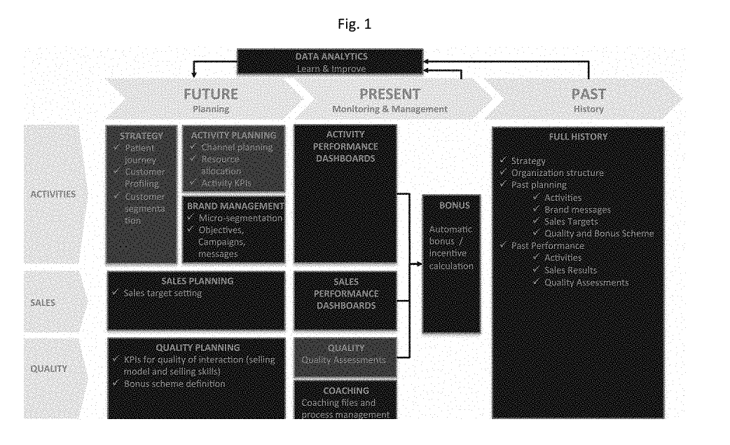

For each of the foregoing time horizons, embodiments of the invention may manage the components of sales performance or performance management, namely: (1) activities; (2) quality of interactions and engagement; and (3) results (sales and sales metrics). FIG. 1 describes these components in each of the foregoing time horizons.

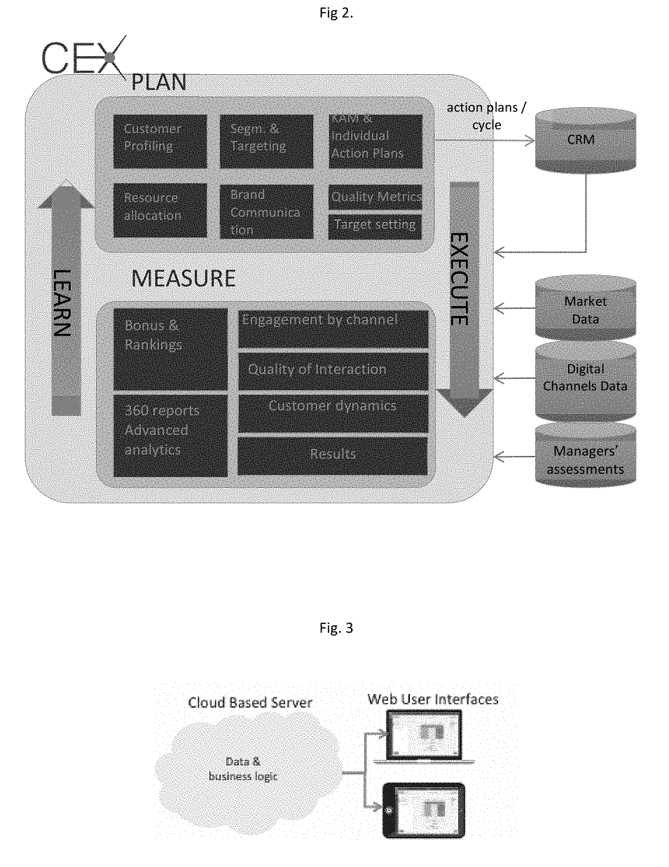

In embodiments, the system may integrate with external systems and data sources, such as: customer relationship management systems (CRM), sales data sources, external assessments for quality of interaction, and digital channels. FIG. 2 shows an exemplary network of external systems and data sources for use with embodiments of the system.

By involving all stakeholders in the sales and marketing organizations—e.g., marketing organizations from country manager, business unit directors (national sales managers), regional sales managers, sales representatives, and brand managers—the system may provide support as a sales management tool. The strategy, operational implementation, tracking, performance management, and incentives may all be integrated, while the system manages all aspects of performance such as activities, quality, and results. Embodiments of the system may codify and store the full knowledge (history) of past cycles including past strategy, plans, and organizational structure, as well as results.

In embodiments, the system may be a cloud-based web application providing web user interfaces optimized for both desktop/laptop and tablet. FIG. 3 describes an exemplary implementation.

The conventions and approach of an exemplary system will now be described.

A preferred embodiment is team and cycle based such that the strategy, planning and execution monitoring is done at team-cycle level, i.e., for each team separately and for each cycle separately. Planning and visibility may remain available at any level below the team, e.g., area manager or individual sales representative.

In embodiments, investment of the customers may be focused with the highest probability of change in the next cycle. The common segmentation approach used by pharmaceutical companies is based on the potential and adoption of customers, an approach that can generate overinvestments of resources. If a customer has not reacted to the sales activities, by increasing his adoption of the product in a long time, the probability of him reacting in the next quarter is limited, assuming no new information or changes in value proposition are available. Therefore, investing in such a customer is wasteful.

The key objectives of the sales and marketing organization are to drive an increase in customer adoption of their product or to prevent a decrease of adoption. Therefore, if a customer has a low probability to react to the sales efforts, or if a customer will not decrease his adoption if there are no sales efforts invested in him, he is a low change probability customer. Companies should minimize their investment in low change probability customers to reduce waste.

The speed of change may be utilized as a predictor of future behavior of customers. As described above, the current level of adoption (customer attitude towards the company product) is an imperfect predictor of how the customer will react to the company's sales efforts. The speed of change in adoption (or any metric which has a progression) is a much better predictor of future behavior and should be considered in the customer segmentation. For example, a customer who has been at the user adoption level for one quarter is more likely to evolve to loyal, than a customer stuck in the user level for ten quarters. This approach is referred to as dynamics driven segmentation.

The traditional approach of customer segmentation utilized in the pharmaceutical industry and other industries is to have a unique profile and a unique assigned segment for a customer in relation with a brand (product). We propose a more refined approach to customer segmentation to address the business need for a finer and smarter customer segmentation.

For example, a pharmaceutical product (drug) may have multiple indications, which means that the same drug can be used to treat different diseases, such as depression and anxiety. The same customer (doctor) may be a high prescriber of this drug for depression but a low prescriber for anxiety, which means that this customer cannot fit into a single profile and segment, but it is more reasonable to have two different segments for this same customer, one for depression and one for anxiety. A subtler example is when for the same drug (brand) and same indication the pharmaceutical company has two different objectives, such as increasing the initiation of new patients on the drug and to increase the re-prescription of this drug to recurring patients. If we take two different customers, one may have many new patients but few recurring patients (i.e. hospital doctor) and the other few new patients and many recurring ones (i.e. outpatient clinic). In this case, for the first customer the company should invest more interactions focused on increasing initiation and less on re-prescribing, and vice versa for the second customer. This implies that each customer should have a specific profile and segment for each of the two objectives. The novelty of the proposed approach is that the segmentation is no longer done just at brand level but at brand attribute/objective level meaning that the same customer can be in one segment for a brand attribute and in a different segment for another brand attribute. Our approach is to treat the same person customer as if she were two different customers, one for each attribute/objective.

The decisions on type of engagement and level of investment is no longer done at person level but at the person-objective level. For example, we assign ten engagements (calls) to doctor X for the objective initiation and three engagements (calls) for the objective continuation. With this approach, we avoid the need to generate a large number of customer segments equal to all the possible combinations of relevance for each objective and assign specific investment for each combination. Instead, the investment or number of engagements allocated to a person is a sum of investments for each brand attribute. We call a customer-brand objective/attribute combination a customer-engagement-unit. A parallel of this approach can be seen in the telecommunication industry where the same person may be a customer of voice, data and cable services, and is considered as three RGUs (revenue-generating-units)

Experience and history may similarly be incorporated. The current systems (CRMs and BIs) used by pharmaceutical companies only focus on execution metrics and results. Without the context coming from the strategy, plans, organization structure, territory allocation, and the like, one cannot correctly interpret and learn from the past experience. the system captures the full context of both strategy and execution/results and organization structure for every cycle in the past. It also tracks key assumptions on which the strategy was based and thus enables two very important benefits: (a) knowledge management (codification, easy access and easy transfer) and (b) systematic learning and refinement from cycle to cycle.

Various strategy and activity planning in embodiments of the system will now be described.

The traditional planning of activities in the pharmaceutical sales context is a top-down plan in which all representatives receive the same activity targets that are calculated based on an assumed average number of days available and an average distribution of customer.

In reality, each representative will take different number of vacation days in a certain cycle, and will plan slightly different activities. Moreover, the distribution of customers varies across territories and reps. Therefore, the top-down approach generates plans that are not adapted to the reality.

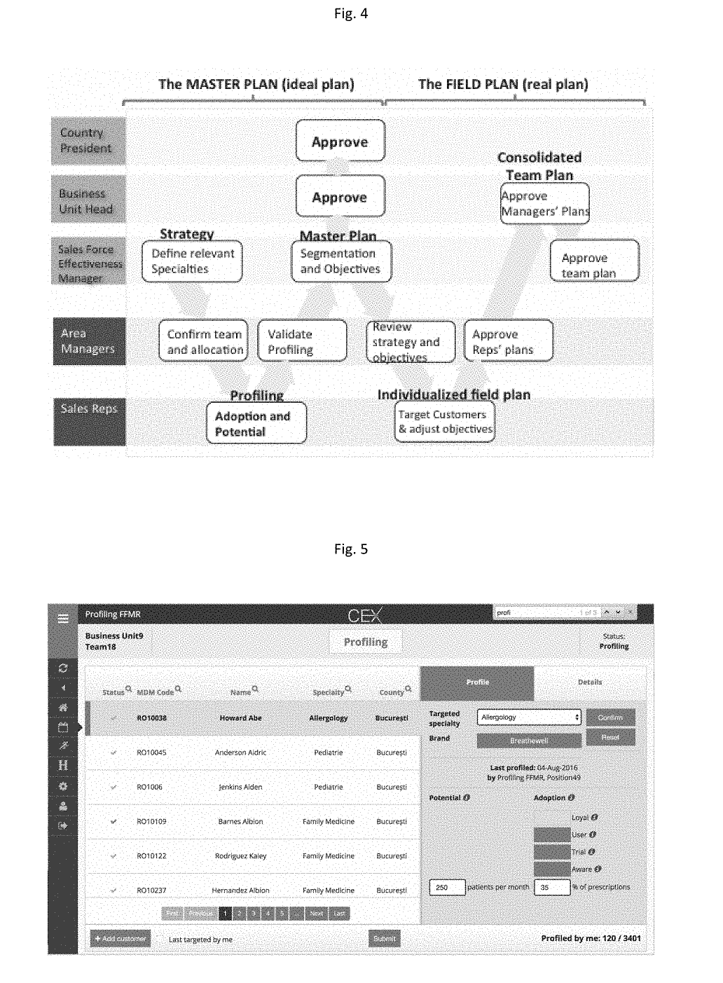

The system splits the planning process into two phases: (1) a master plan used for high-level sizing and resource allocation; and (2) field planning in which the plans are individualized by the representatives and consolidated upwards. FIG. 4 describes such a framework.

Customer profiling may associate certain characteristics and levels with individual customers. Profiling information may be used to segment and prioritize customers and to adapt messages to them. Typical profiling dimensions may include: (1) potential, tracking the number of relevant patients a customer treats in a month; (2) adoption, tracking the percentage of patients treated with the company product measured at levels such as aware, trial, user, loyal, and advocate; (3) preference, tracking customer preference as innovator, early adopter, follower, and laggard. Customers may be profiled by any number of dimensions.

In many countries is not permitted by regulation to disclose sales or prescription information at a customer level, and the providers of sales data issue this information at a higher level of aggregation such as country or bricks (larger group of customers). These restrictions complicate sales and marketing management and impedes measurement at an individual level.

It is preferable that customer segmentation be done based on updated customer information or it remains a theoretical exercise. To address data availability and regulatory constraints, embodiments of the system require sales representatives to provide customer potential and adoption information, based on their perception and knowledge of their customers. This sales representative customer profiling as a precursory step to the segmentation strategy is a new approach brought in by the system.

FIG. 5 describes a customer profiling interface.

In embodiments, a targeted specialty may be incorporated. A customer may have multiple specializations, in which he is trained and which are recognized by the authorities. For a certain product and a certain team only one of the specializations is relevant. Other teams on other product may target the same customer but with a different specialty. It is important to know by which specialty we profile, segment and target a customer.

Additionally, there may be cases where a customer (HCP) does not formally have a certain specialization, but he may play the role of an HCP with that specialization. For example, in remote locations an internal medicine doctor will also substitute a pulmonologist.

To address these cases, a targeted specialty is utilized, which is the specialty by which we profile, segment and target a certain customer for a certain team in a certain cycle. This may or may not be an officially recognized specialization for that customer.

In embodiments, potential analyses and thresholds are considered. In order to translate the individual profiling information into actionable information customer must be divided into discrete groups. For potential dimension, the customer is split into three levels: high potential, medium potential, low potential.

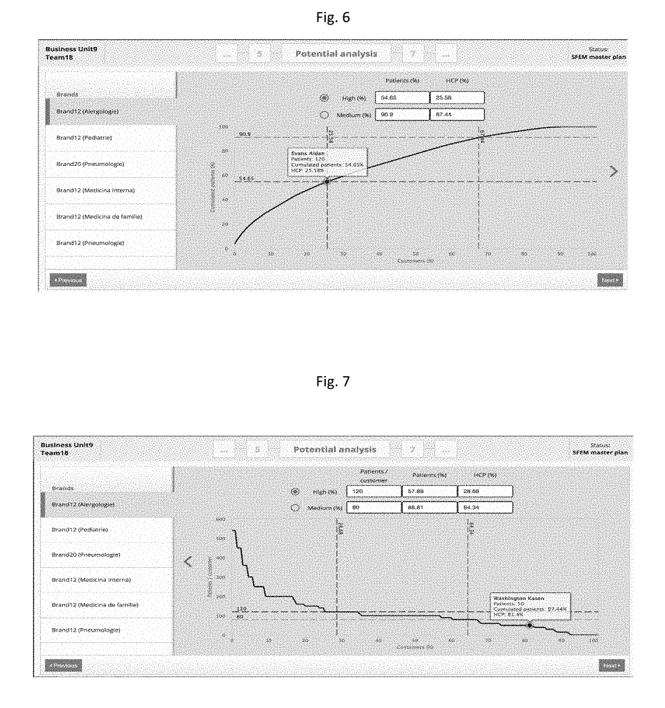

The traditional approach to define the cut-off points is to use the “concentration curve” which sorts the customers in descending order of their potential (number of patients) and on the Y-axis, show the cumulated number of patients covered from the first customer to the current one. FIG. 6 shows such a concentration curve.

For example, a decision may be driven by the following rationale: “I want to treat the customers that cumulate 70% of total patient potential, as high.” However, the problem with this approach (looking only at cumulated potential) is that the cut-off can be set in the middle of a pull of customers who have the same potential. Therefore, two customers having exactly the same number of patients may be treated differently—one as high potential, the other as medium potential. Looking at the concentration curve only we would miss such situations, which are quite common.

To address this issue, we introduce a new curve, which shows on the Y-axis the individual potential of the customer, not the cumulated one, which is referred to as the potential curve. FIG. 7 shows the potential curve implementation in the system. The cut-off point for high potential as shown in FIG. 7 is the blue line, which is set in the middle of a flat segment.

In embodiments a user may manually adjust the cut-offs to eliminate sub-optimal decisions in customer prioritization.

Embodiments of the system adopt a new approach and tool to set the potential cut-off points by utilizing in sequence the concentration curve and the new potential curve.

Embodiments of the system may also implement an automatic algorithm that recommends cut-off points based on the history of the cut-off points set by the company on customer cohorts with similar distribution of potential, i.e., similar concentration curve and standard deviation.

Customer segmentation may be utilized with embodiments of the system. Customer segmentation aims to group customers into a limited number of groups which are significantly different from each other so that they can be approached differently. For example, a different level of investment may be used per group where investment is defined as the intensity of interactions minus number of visits, calls, etc. Different messages and value propositions by may also be offered by segment.

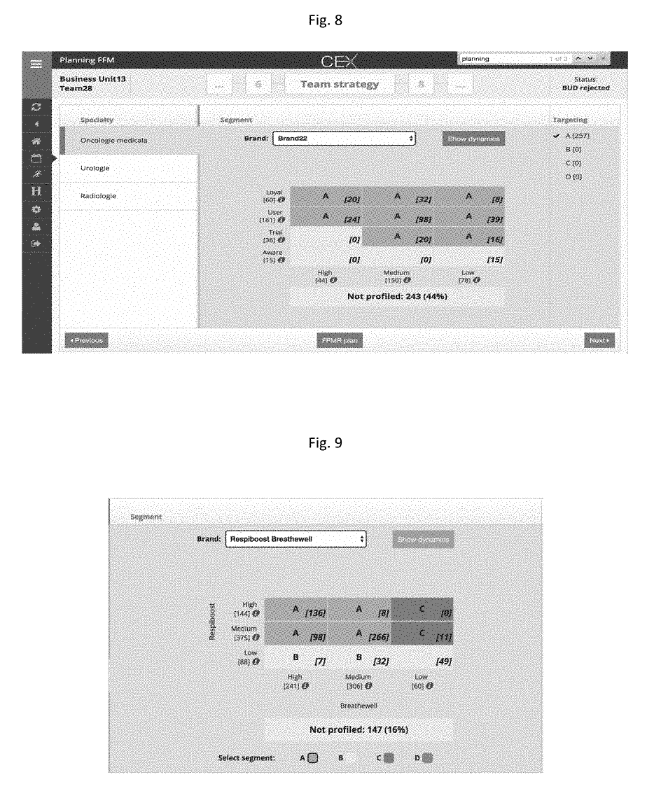

In the system, pharmaceutical companies may use the traditional segmentation matrix, which is shown in FIG. 8.

The traditional approach is to bundle together customers (HCPs) of all specialties targeted by the team and segment them. In embodiments, segmentation may be accomplished on a specialty level—for each specialty—because specialty is a natural way to segment customers, and bundling them together is against the spirit of segmentation—identifying customers that are the same.

In embodiments, a customer segmentation strategy will reflect the product strategy and the stage in its lifecycle, so that the segmentation will reflect an attack/grow strategy, defend strategy or retreat strategy. The system can provide suggested segmentation approaches, based on the product life stage.

If more than one products are promoted to the same type of customer, the segmentation may be done by the priority product in the portfolio. However, there may be cases in which two products may be equally important: one that we want to launch/grow at the customer and one which we want to defend. In such a case, the system provides an innovative way to segment customer by looking at the intersection of potential for the two products. FIG. 9 shows an example segmentation matrix.

In the system, the user may utilize not only potential and adoption to segment customer, and the Adoption dimension can be substituted for another segmentation dimension, defined by the user such as preference as an innovator or early adopter, for example.

### Customer Dynamics

Traditional segmentation looks at the static picture of customers and may be based on the latest customer information. The ultimate aim of segmentation is to identify where to concentrate the sales investment. the system view is that the focus should be on the customer groups with the highest probability of change: (1) customers who are likely to increase their adoption if engaged sufficiently; and (2) customers who are likely to decrease their adoption if not engaged sufficiently.

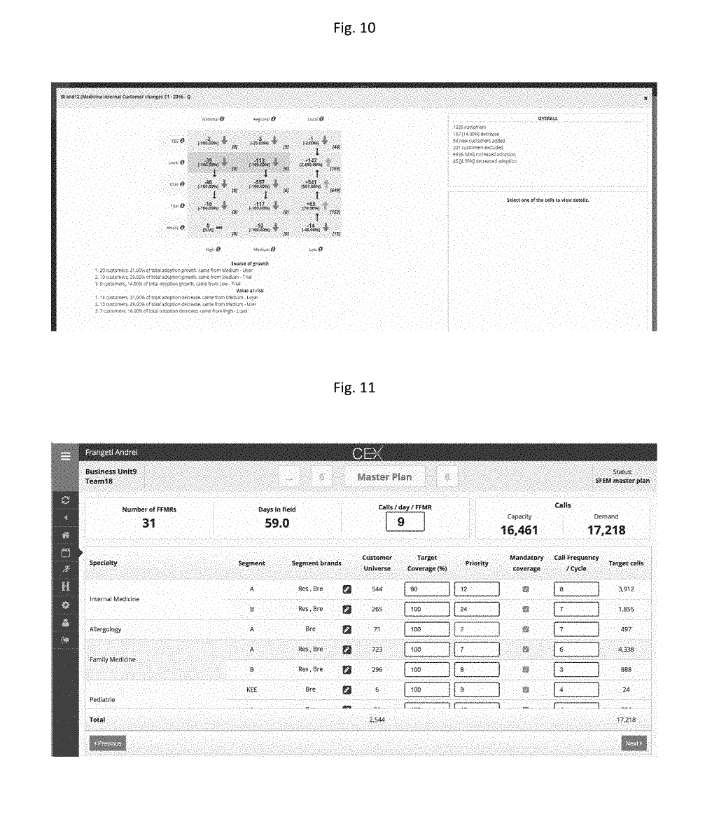

The current profiles of customers, specifically the current adoption level is not the best predictor of future behavior of the customer. A customer who has been loyal to the product for a long time is more likely to remain loyal in the next cycle, compared to a customer who just become loyal in the last cycle, and who may be swayed back by the competition. FIG. 10 shows a screenshot of an exemplary customer dynamics matrix.

To address this the system looks also at the customer dynamics in potential and adoption.

The dynamics screen shows the customer changes in potential and adoption and identifies automatically: (1) sources of growth, namely areas (potential-adoption cells) that generated most of the adoption growth of this specialty; and (2) value at risk, namely areas (potential-adoption cells) that generated most of the adoption decrease of this specialty. Using the insights from the customer dynamics, the user can go back into the segmentation matrix and refine the segmentation.

The system introduces the notion of “age.” which represents the number of cycles a customer has spent on the same adoption level. Age represents an inverse measure to the velocity of change in adoption and is a better predictor of the behavior of the customer in the next cycle, compared to the adoption level alone.

By calculating the dynamics information, the system introduces two new dimensions for customer segmentation: (1) adoption change—direction of change and (2) speed of change—age. This new approach to customer segmentation allows a much finer and precise segmentation of customers, by inferring the probability of adoption change in the new cycle and allowing the focus on customer with higher probability of change.

### Multichannel Customer Engagement

The communication of Pharmaceutical companies to the customers may happen over multiple channels. Not all customer types—segments—may be profitably served by every channel, nor accessible by every channel. CEX offers a systematic process in which the Pharmaceutical companies can link each customer segment to a specific mix of channels and furthermore break down the communication objectives by channel. The channel planning is done for each brand, but a certain channel will be utilized for multiple brands. CEX automatically consolidates the brands for each channel to support the channel sizing and resource allocation decisions. By differentiating between channel types and channels—a new concept introduced in CEX—we allow a more flexible multichannel engagement: i.e. email is a channel type, but emails can be used by sales reps to follow up on their customer calls and they can also be used by the back office to communicate other elements; these two cases have very different objectives and require different resources and effort and therefore we treat them as different channels of the same type. The advantage of this approach is that it ensures a consistent approach across channels, it provides the big picture channel strategy and very importantly streamlines the communication and collaboration between the different internal stakeholders involved: product managers, channel managers, commercial excellence managers, digital experts etc.

### Content Planning and Content Analytics

Pharmaceutical companies communicate key benefits attributes and supporting evidence to their customers—the healthcare professionals. The communication is centered around some key objectives and key messages. The information is communicated through various channels in the appropriate formats for each channel. There are two key challenges that the Pharmaceutical companies face: i. ensuring that they tell a consistent and aligned story across channels, ii. measuring the interest of customers for each of the key messages. We solve the first challenge by continuing the multichannel planning process with the content planning and mapping at segment-channel level. The second challenge is more complicated because the same key message (idea) will be implemented very differently from channel to channel. Currently any the implementation of the same key message on different channels is treated and measured as separate messages. The complication is that when we measure interest of a certain message on a channel, and find out that the interest is low, we cannot tell whether the customers are really not interested in that information or the implementation in that channel was not a good one. The way we solve this issue is that we assign a unique code to each key message, the implementation of that message on a certain channel will receive a code that is a combination of the unique message code and the channel code. The resulting code will be inserted in the digital asset (website, email, e-detail application) so that the statistics gathered for the page (section) associated with the message are associated with the provided code. Doing this we are able to tell that two different messages from different channel are actually implementations of the same message. We measure relative interest of messages for each channel and also the compounded relative interest across channels: i.e. if we have 5 key messages together they will have 100% of the interest of the audience and we measure the portion that each message captures, message one captured 50% of the attention. For each channel this is measured using channel specific KPIs (open rate, click through rate, time on page, accesses/user etc.). We also calculate a compounded—cross-channel—interest of the message. If the cross-channel interest is 30% for message one and the email interest is 15%, the inference we make is that the quality of the implementation on email was not adequate and therefore it elicited a smaller interest than overall. This way we measure both the interest in a certain topic and the quality of implementation by channel. To our knowledge the cross-channel content analytics is a unique approach in the Pharmaceutical industry. Furthermore, the same key message—superior efficacy—can be presented from different perspectives—putting emphasis on patient benefits, or putting emphasis on the scientific aspect of the mode of action. For each implementation of the key message we can add perspective tags, i.e., [PatientOriented], [ScienceOriented]. By measuring the engagement and interest for each tag of a certain customer across key messages, we can infer their attitude/preference and use this information for behavioral segmentation and adapting the engagement accordingly.

The content planning flow is the following:
a) Start from the brand objectives and list the key messages relevant for the brand in the following promotional cycle
b) Map the brand objectives and messages to the segments
c) For each customer segment further split the objectives and messages by channel, taking into consideration the channel role. The result is a map between key messages and segment/channels and the associated list of content deliverables that the marketing, digital departments need to produce. It generates in effect a list of deliverables and project plan for content creation.

### Preference/Behavioral Inference

The “age” information discloses how fast a customer progresses in adoption levels. In embodiments, the system implements an algorithm which looks at the speed of change in adoption of the same customer across several product launches and is able to infer form this data which customers are early adopters, followers, and late adopters. Thus, the system may facilitate data-driven behavioral segmentation based on past behavior of customers.

### Sizing and Resource Allocation

Based on the segmentation strategy, the system may allow the calculation of effort investment by segment to balance with the availability of resources. FIG. 11 shows a screenshot of a resource planning function used in embodiments of the system.

### Knowledge Management and Systematic Learning

In the system, the user creating the plan for a team will introduce the synthesis of the mission and strategy for the next cycle as well as the key assumptions on which the strategy is based. This information together with all the strategy, planning as well as execution information may be stored for each cycle, effectively codifying the knowledge and experience of the organization.

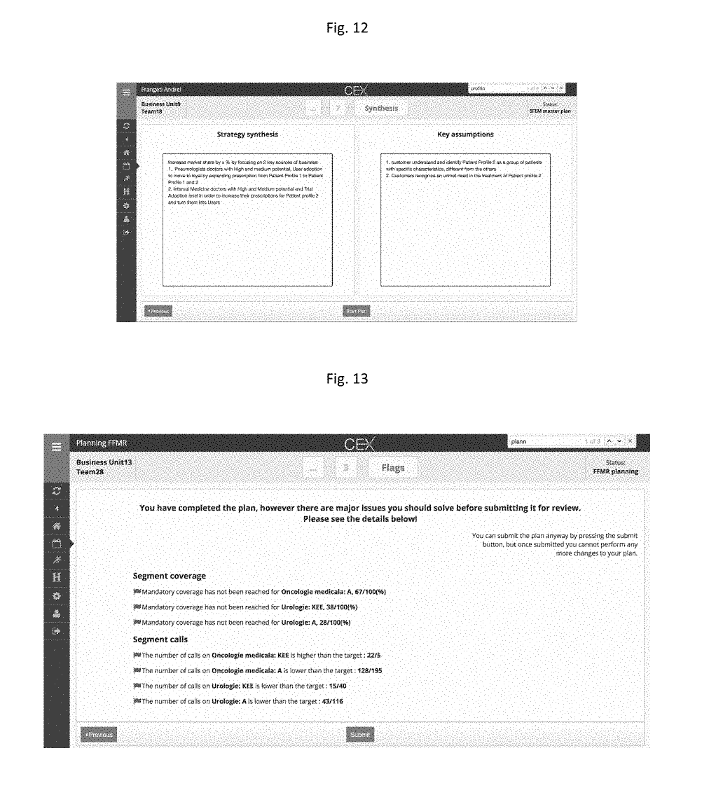

The system implements tracking of strategic assumption, and validation (invalidation) of assumptions that allows the organization to learn and refine their strategy and approach in a predictable way. FIG. 12 shows a sample strategy synthesis and corresponding key assumptions.

### Field Planning—Bottom Up Section of Planning

In embodiments, the first part of the planning—the top-down—starts from the strategy and generates a high-level plan that is based on averages and assumes a similar distribution of customers across territories. In the second part the individual sales representatives adapt their plan to their own reality while trying to observe as close as possible the directions and targets defined in the first step.

The system performs automated analyses of the bottom-up plans—at all levels including sales representatives, area managers, national—and compares it to the top down (ideal) plan. The gaps identified are signaled to the users as flags, red or amber, based on severity.

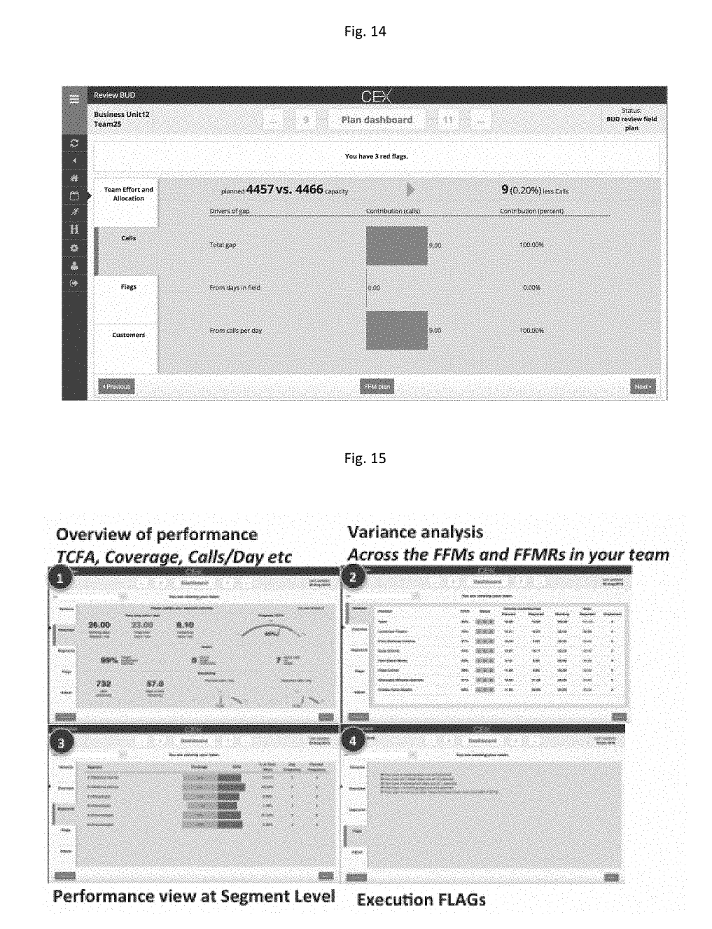

FIG. 13 shows a screenshot of an automated gap analysis and identification signaled through flags used with embodiments of the system. FIG. 14 shows an automated root cause analysis for the gaps in the plan.

### Activity Execution Monitoring in The System

The system generates execution performance dashboard that compare the reported activities with the plan and measures progress. It identifies main gaps between execution and plan and focused the attention. FIG. 15 shows an automated gap analysis between the progress and the plan and synthesize the gaps through flags, as used with embodiments of the system.

In embodiments, velocity is factored into the system, defined as number of contacts per day.

Traditional sales force effectiveness KPIs look at the realized number of contacts per day, but due to reporting limitations in the CRMs this is generally not a very precise number, moreover it does not give a clear sense of whether the overall target is achievable or not.

Instead the system calculates the required velocity (contacts/day) to meet the target number of contacts for the cycle. If this exceeds a certain threshold, of reasonable contacts/day achievable with good quality of contacts, the system automatically notifies the manager to make appropriate corrections.

Required velocity is an effective trigger of managerial decisions, whereas achieved velocity is just a backward looking, reporting measure.

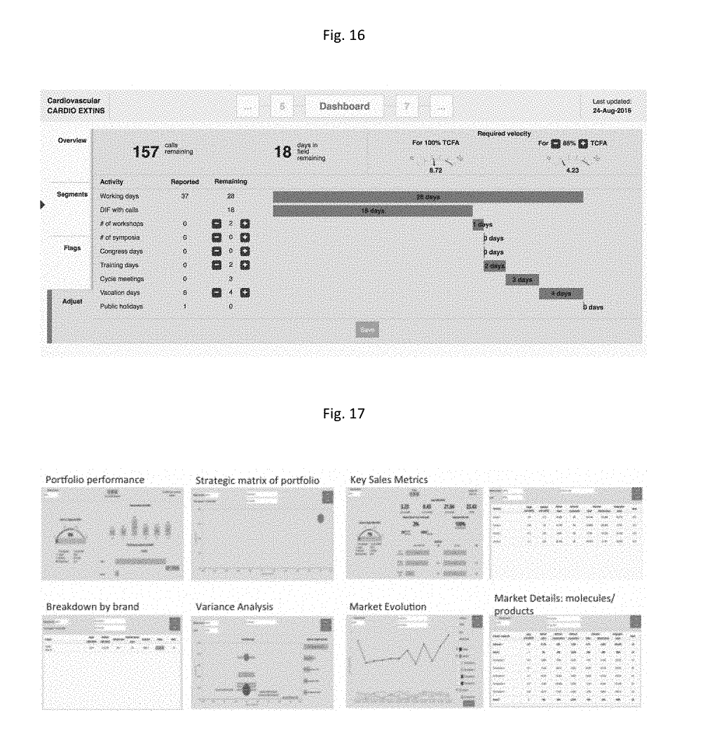

The system enables mid cycle adjustments of activities, in order to reach the target. It helps the user to simulate what would be the optimal mix of activities, as shown in FIG. 16.

In embodiments, the system implements a sales target setting process, in which sales (market share and growth) targets are set at a product and SKU level for the next cycle. Sales targets are set for each individual month of the planning cycle. An exemplary target setting process may follow the following steps: (1) set product sales targets at national level; (2) automatic breakdown of targets at the smallest territory level; (3) manual adjustment of targets at smallest territory level; (4) consolidation of targets at Sales Representative level; and (5) final targets approval

### Target Breakdown

Breaking down the sales target of a product from national to territory level can be done utilizing user defined rules. The default implementation used the following geo distribution formula:

stᵢ=st_{N}*(pᵢ%*w+mkᵢ%*(1−w)) where:
a) stᵢ—is the sales target on territory i for selected product
b) st_{N}—is the national sales target on for selected product
c) pᵢ%—is the proportion of the product sales in territory i versus national level
d) mkᵢ%—is the proportion of the market sales in territory i versus national level
e) w—is the weight given to the product geo share (pᵢ%)

In a territory that outperforms the average growing the performance further is more difficult, some degree of regression to the mean is expected. Similarly, in the underperforming territories the sales targets should push for a “catch up” toward the mean.

Using an automatic distribution formula from national targets to territory target cannot take into account other territory specifics, i.e. the sales representative covering that territory is junior and is expected to perform less than an average sales representative.

For this reason, the Area manager can manually adjust the targets for specific territories.

In many cases there are more than one team (promotional line) that detail the same product in the same territories. Therefore, manual adjustments done by the area managers in each of the teams may lead to diverging sales targets for the same territory. Because the sales information is available only at territory level, the targets for the same brand for all teams but be equal for each territory.

The system implements an algorithm to automatically detect target conflicts across all teams and a process to align the final targets.

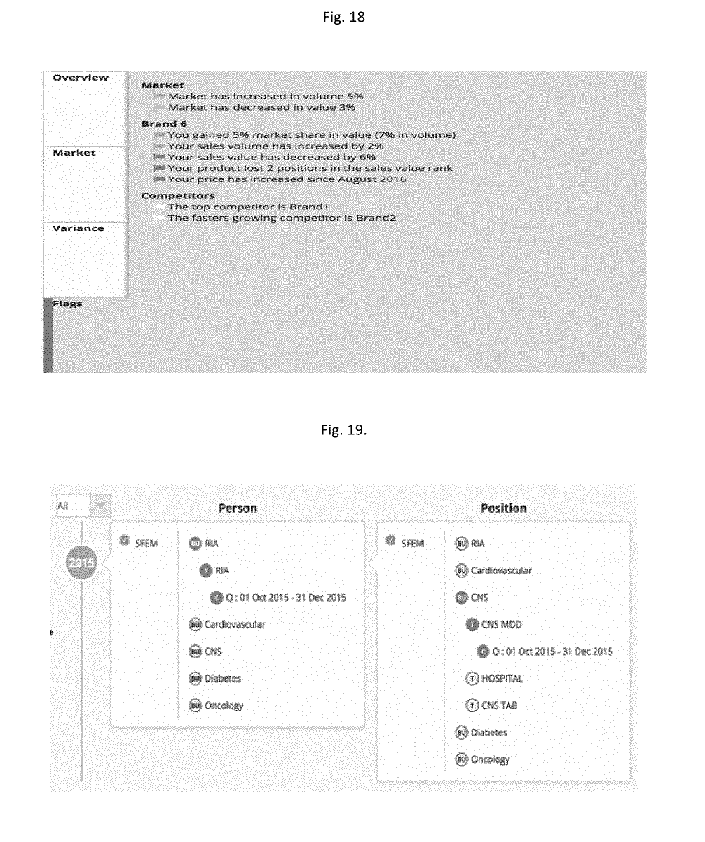

A sales dashboard is shown in FIG. 17. For users with sufficient access privileges, the system may import sales data and automatically generate sales analyses and dashboards available. As shown in FIG. 18, the system implements also in the sales dashboard the flag systems, which automatically synthesize in words the key conclusions from the market analysis.

### Quality and Incentive Planning in The System

The quality of interaction between the sales representative and the customer is a key driver of sales, and there are multiple dimensions that drive the quality of interaction. Each company will have its own model for selling quality and selling capability.

In embodiments of the system, the companies can define the dimensions of their selling and capabilities model, define for each dimension the grading scale, and also set the weights and relative importance of each dimension.

Corroborated with the sales and activity KPIs and targets the companies can define the incentive scheme structure (formula). In the bonus/incentive scheme they can define which dimensions are “qualifiers,” what are the weights for the different dimensions and what is the payout curve.

Defining the selling and competency model and the incentive scheme is done through a process that involves multiple actors in the company and ensures validation and sign off. Companies have the freedom to set different models and incentive scheme for the different teams to account the specifics of the team and the lifecycle of their portfolio.

During the execution, the system will collect grade and ratings on each of the selling model dimensions as well as the activity and sales results. the system also includes a documented coaching process, capturing the development plans and their execution agreed between the sales reps and the managers.

Based on all the information above, the system can perform an automatic bonus calculation.

### Validating the Selling Model Through Data

In embodiments, the system implements an algorithm that looks at the history of grades over different dimensions that the sales reps with the highest sales results achieve. From this we identify which of the different dimensions are the better predictors of sales performance and feed this information back into refining the selling model. The analysis may be segregated by therapeutic areas, as what works in a certain context (oncology) might not be as relevant in another context (primary care).

The system also looks at the correlation between manager performance and their past performance as sales reps to identify which elements and dimensions could be a good predictor that a representative will become an effective manager.

### History and Knowledge Management

The knowledge accumulated by the people and organization through the experience of the previous quarters is an important asset in driving continuous refinement and evolution.

The traditional systems, including CRM software and business intelligence, only store information about what the organization did or achieved. While this is important information it is not sufficient to draw solid conclusions, and provide an experience from which to learn. The system fills this gap by also capturing the other information that helps complete the picture, including: (1) strategy, segmentation and targeting; (2) key assumptions about the external environment; (3) KPIs and the targets; (4) organization/team structure and in field deployment; and (5) individual customers reactions. By having this complete picture about the past and having easy access to it, the organization can use the knowledge for continuous evolution.

In embodiments, the system provides a new way of looking at history, from two perspectives. First, a person perspective is considered in which a person may move across multiple positions in the organization. This perspective shows the history from the person perspective on each position he has occupied in the past. Second, a position perspective is considered. A position in the company will be occupied by different people at different points it time. The position perspective shows the details of every cycle of the respective position, irrespective of who occupied it. It is a great transfer knowledge instrument for the new person on a position as she can instantly access the thinking and experience of her predecessors.

To access the history of the past cycle, one needs to select the perspective and the cycle. FIG. 19 demonstrates an embodiment of this concept.

No matter the perspective, when selecting a past cycle one can access all information relevant to that cycle, including:
a) the strategy, segmentation and targeting
b) the key assumptions about the external environment
c) the KPIs and the targets (both activities, sales and quality)
d) the organization/team structure and in field deployment
e) the individual customers reactions: changes in adoption
f) achieved performance and results
g) coaching history

The system implements a software solution that brings new flavors and perspectives on the traditional approach and acts as an operating system pharmaceutical sales and marketing excellence.

It is a unique solution that does not fall in the traditional categories of CRM or business intelligence. On a high level four key differentiation points are:
a) The new perspective of customer segmentation and investment allocation, based on probability and size of impact.
b) The end-to-end coverage of Sales and Marketing process from strategy and planning to execution monitoring and performance management.
c) The combination between data and a step by step process that facilitates and drives decision making.
d) The unique way in which the system stores the history and knowledge, including past organization structure, past strategy, KPIs and targets, past execution, results, appraisals and incentives.

Beyond the top-line differentiators, the system brings numerous innovations in the implementation of the various aspects and tools of pharmaceutical sales and marketing Excellence.

It will be understood that there are numerous modifications of the illustrated embodiments described above which will be readily apparent to one skilled in the art, including any combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A method of focusing the investment and attention of a sales and marketing organization performed by one or more processing devices, comprising:
generating a customer trend profile that including sources of growth and value at risk to define a subset of a customer base having the highest probability of change in a sales period, and focusing resources on the customers in said subset;
determining the dimensions that are the best predictor of a sales representative's success and focusing performance management on those dimensions;
allocating the channels and engagement tactics to which a customer is more likely to respond, based on the history of interactions.

2. The method of claim 1 further comprising the step of managing the components of sales performance incorporates at least one time horizon chosen from the list of: future, present, and past.

3. The method of claim 2 wherein the step of managing the components of sales performance incorporates evaluation of at least one of: (a) activities; (b) quality of interactions and engagement; and (c) sales and sales metrics.

4. The method of claim 3 wherein the step of managing the components of sales performance incorporates evaluation of strategy, activity planning, and brand management.

5. The method of claim 3 wherein the step of managing the components of sales performance incorporates evaluation of sales planning or quality planning.

6. The method of claim 3 further comprising the step of utilizing a dashboard module to display activity performance or sales performance.

7. The method of claim 3 further comprising the step of utilizing a history module to provide data related to past planning or performance.

8. One or more storage devices storing instructions that are executable to perform operations comprising:
generating a customer trend profile that including sources of growth and value at risk to define a subset of a customer base having the highest probability of change in a sales period, and focusing resources on the customers in said subset;
determining the dimensions that are the best predictor of a sales representative's success and focusing performance management on those dimensions;
allocating the channels and engagement tactics to which a customer is more likely to respond, based on the history of interactions.

9. The storage device of claim 8 further comprising the step of managing the components of sales performance incorporates at least one time horizon chosen from the list of: future, present, and past.

10. The storage device of claim 9 wherein the step of managing the components of sales performance incorporates evaluation of at least one of: (a) activities; (b) quality of interactions and engagement; and (c) sales and sales metrics.

11. The storage device of claim 10 wherein the step of managing the components of sales performance incorporates evaluation of strategy, activity planning, and brand management.

12. The storage device of claim 10 wherein the step of managing the components of sales performance incorporates evaluation of sales planning or quality planning.

13. The storage device of claim 10 further comprising the step of utilizing a dashboard module to display activity performance or sales performance.

14. The storage device of claim 10 further comprising the step of utilizing a history module to provide data related to past planning or performance.
